(19) United States
(12) Patent Application Publication
(10) Pub. No.: US 2012/0082372 A1
(43) Pub. Date: Apr. 5, 2012

(54) AUTOMATIC DOCUMENT IMAGE EXTRACTION AND COMPARISON

(75) Inventors: SUSHIL MITTAL, HIGHLAND PARK, NJ (US); SRIDHARAN PALANIVELU, MONMOUTH JCT., NJ (US); YEFENG ZHENG, DAYTON, NJ (US); SARAH WITZIG, LANGHORNE, PA (US)

(73) Assignee: SIEMENS CORPORATION, ISELIN, NJ (US)

(21) Appl. No.: 13/211,366

(22) Filed: Aug. 17, 2011

Related U.S. Application Data
(60) Provisional application No. 61/388,725, filed on Oct. 1, 2010.

(51) Int. Cl. G06K 9/62; G06K 9/34

(52) U.S. Cl. 382/159; 382/173; 382/170; 382/165

(57) ABSTRACT

Systems and methods are described that extract and match images from a first document with images in other documents. A user controls a threshold on the level of image noise to be ignored and a page range for faster processing of large documents.

### CROSS REFERENCE TO RELATED APPLICATIONS

This application claims the benefit of U.S. Provisional Application No. 61/388,725, filed on Oct. 1, 2010, the disclosure which is incorporated herein by reference in its entirety.

### BACKGROUND OF THE INVENTION

The invention relates generally to document image extraction and comparison, where an image corresponds to an image, table or form embedded in a document. While a document may be a Portable Document Format (pdf) or PostScript format, an image embedded in the document may be formatted as a standard digital image such as .pdf, .jpg, .bmp, .tiff or other. More specifically, given two documents, embodiments independently extract images from each document, and match and compare the extracted images across the two documents for changes. Embodiments may extract, match and compare images across more than two documents.

Automatic document image analysis refers to the process of extracting textual and graphical information from scanned documents using computer algorithms and techniques. Some applications of document image analysis are Optical Character Recognition (OCR), graphics analysis, recognition and classification, document classification and document comparison.

Comparing two or more documents for changes (also called redlining) automatically, is a challenging problem and is less studied than the above mentioned applications. Different versions of the same document can have different changes made by multiple editors. Due to this, the size, position, resolution and orientation of objects (text, tables, forms or images) in the document may vary from one version to another. Some objects may not be present at all in certain versions while some additional objects might be present in the same versions. Often, the number of pages is not the same among the various versions and the pages lack a one-to-one correspondence. Tracking these changes manually either by annotating the document or by keeping a change log is a tedious and error prone task especially when documents are several pages long, the changes are minor or the images in the document are large, for example, floor plans of buildings, engineering drawings of complex machinery, etc. Also, different types of noise acquired during document scanning add to the complexity.

Document comparison has a large number of applications for various individuals and industries ranging from print and creative media to accounting and financial industries. Based on the application, different document comparison software exists. In most cases, the software algorithms are designed for comparing text documents with a strong emphasis on OCR to recognize changes in text size and font type. Apart from text, specialized software compares presentations, spreadsheets, etc. This means that an algorithm designed or trained to detect changes in forms may not be able to detect changes in images and vice versa. A versatile document comparison algorithm should be able to process documents containing different object types including text and images, and highlight the changes even in the presence of noise.

When processed through a digital document scanning device, a physical document is converted into digital media that can be stored on a computer. During this process, images contained in the digital document are broken down into pixels. Noise plays an important role in all automatic document image analysis algorithms, especially for scanned documents. The scanning process is prone to various kinds of noise. The overall brightness or contrast might vary from one version to another due to differences in the scanning mechanism or lighting conditions. Certain colors in the images may not be captured properly or can appear faded in certain versions of the document. In many cases, the pages are not aligned properly or have holes, staples or paper clips while scanning and are detected as images. An algorithm for document comparison should therefore be sufficiently robust to all types of noise. At the same time, the algorithm should not be oversensitive to noise. Even copies of the same document scanned twice are not the same when compared at the pixel level. The algorithm should be adaptable to the amount of noise that can be tolerated by the user. Further, these thresholds on the levels of tolerable noise could be different for text and images based on the sensitivity of the document to the respective changes.

An automatic algorithm for document image comparison for corporate use should be fast due to large document sizes. The number of images in the documents may be large and detailed. The accuracy of the detection results affects the performance of any such algorithm. As discussed above, the level of accuracy should be a parameter that can be controlled by the user. A small increase in computational efficiency should not deteriorate the quality of the image comparison results drastically. Usually, image comparison takes more time to process than text comparison for obvious reasons.

There are a number of different ways in which the processing time for image comparison may be controlled. One way is to process the images at different resolutions for different noise thresholds. Another is to use a different number or even types of features extracted for image comparison. The lack of one-to-one mapping between pages of two versions of a document increases the cost of comparison quadratically with the number of pages. This is due to the fact that in the worst case, every page in the first document would be compared with every page in the second document.

The task can become more complicated where there are many similar looking images in each document.

What is needed is a method and system that efficiently and accurately compares images in two or more documents and identifies the disparities between them.

### SUMMARY OF THE INVENTION

The inventors have discovered that it would be desirable to have systems and methods that extract and compare images across two or more documents. A user controls a threshold on the level of maximum image noise to be ignored by the embodiments. A page range in which embodiments search for a match of a particular image for faster processing of longer documents is an optional input parameter.

Embodiments compare images between documents having different sizes, orientations or aspect ratios. Embodiments use the RANdom SAmple Consensus (RANSAC) method for robust image alignment under an affine transformation which is a general form of 2-D transformation. Image comparison is performed using a region correlation based method and spurious differences are filtered at various stages which increase the method's robustness towards image noise.

One aspect of the invention provides a method for comparing images contained in documents. Methods according to this aspect of the invention include inputting a first document, inputting another document, segmenting the pages of the first and another document into object regions, classifying the object regions as text and images, associating the images from the first document with images from the another document, aligning the associated images using an affine transformation, computing a disparity in the associated images using cross correlation, and displaying the disparity in each aligned, associated pair of images.

Another aspect of the method is wherein segmenting document pages further comprises binarizing the first and another document pages as black and white using a predefined threshold T_{B}, projecting each binarized document page onto x and y axes of the page, computing a page histogram over the number of white pixels along the x and y axes of the page, determining valleys along each page histogram that define an enclosed object region, and if the area of an enclosed object region is greater than an area threshold T_{A} and the width between two valleys is greater than T_{W} pixels, segmenting that object region from the document page.

Another aspect of the method is wherein associating an image from the first document with an image from another document further comprises downsampling each image from the first and another documents, computing a measure of association between a first document image and another document image using a Scale-Invariant Feature Transform (SIFT), storing SIFT features extracted from the first document images and the another document images in a kd-tree (k-dimensional tree) data structure, searching for image matches between the first and the another document images, computing bi-directional pairwise scores between the first document images and the another document images, summing the directional pairwise scores as a measure of association between a first document image and another document image, assembling an association matrix, and associating all of the first document images with the another document images.

Another aspect of the method is wherein aligning each associated pair of images from the first and the another documents further comprises converting each image to grayscale, filtering each grayscale image using a Gaussian filter, and computing two difference images between a first document image and a matched another document image comprising binarizing each difference image into black and white by rendering black all difference image pixels having a grayscale level less than 5 and rendering white all the remaining pixels, and rendering black all white pixel regions having an area less than a fixed maximum threshold T_{N}.

Another aspect of the method is wherein displaying the disparities in each aligned, associated pair of images further comprises for each non-zero, non-edge pixel from a first document image, extracting a rectangular region of pixels centered around that pixel, normalizing the extracted rectangular region and computing a cross-correlation matrix centered around the same pixel location in the matching aligned, associated image in the another document, flagging the non-zero pixel as a difference pixel if the maximum value in the cross-correlation matrix is less than 0.8, and determining a set of pixels in both the aligned, associated images of the first document and the another document images that correspond to differences.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary system architecture.

FIG. 2 is an exemplary automatic document image extraction, matching and comparison method.

FIG. 3 is an exemplary disparity viewer document comparison result.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

Embodiments of the invention provide methods, system frameworks, and computer-usable media storing computer-readable instructions that allow a user to input two or more documents, extract images from each document and match and compare the extracted images to identify disparities. The invention may be deployed as software as an application program tangibly embodied on a program storage device. The application code for execution can reside on a plurality of different types of computer readable media known to those skilled in the art.

Although exemplary embodiments are described herein with reference to particular network devices, architectures, and frameworks, nothing should be construed as limiting the scope of the invention. The following description teaches comparing two documents, however, embodiments may compare more than two documents.

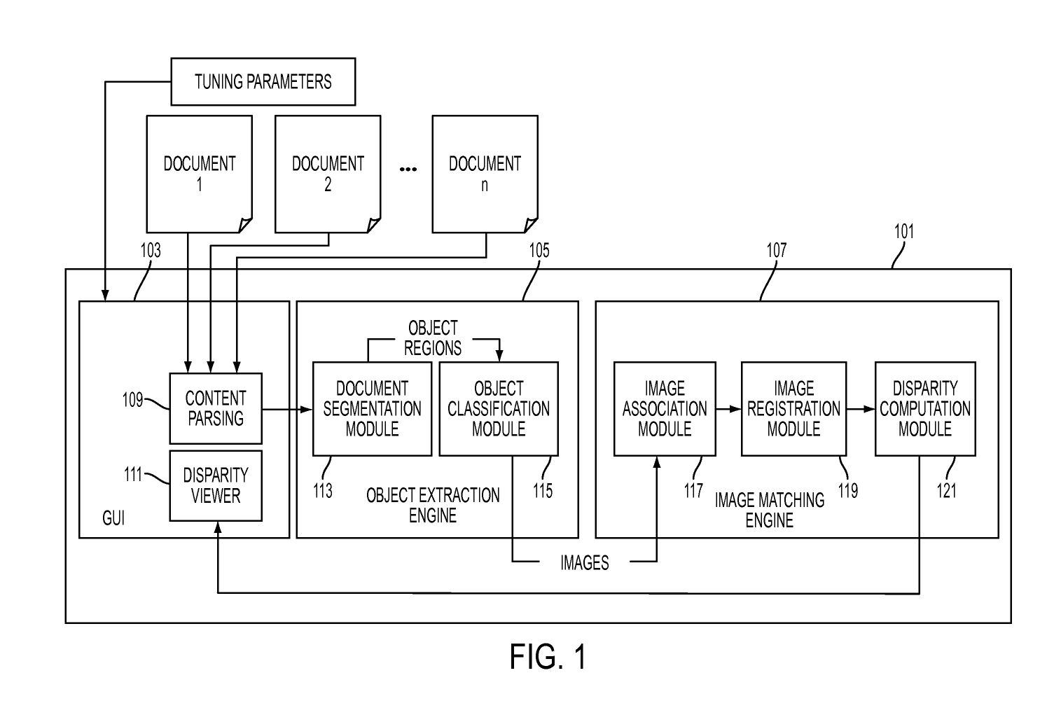

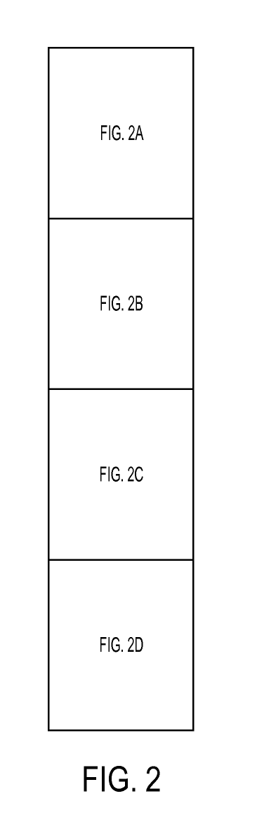

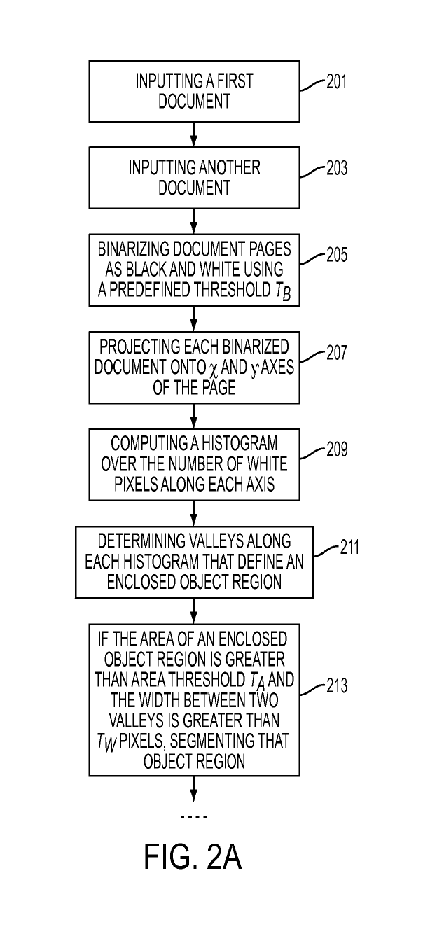

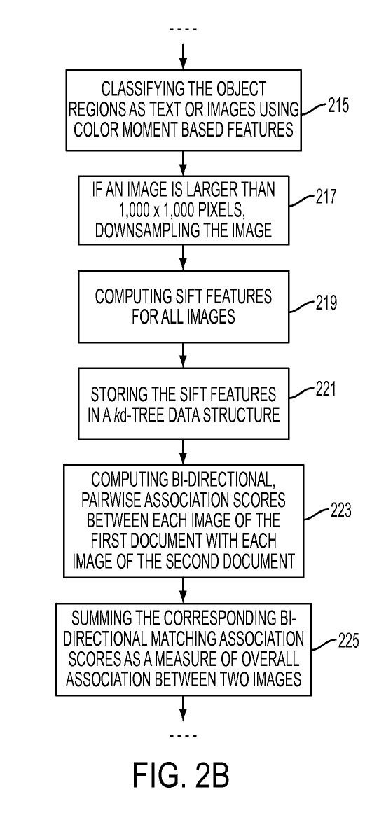

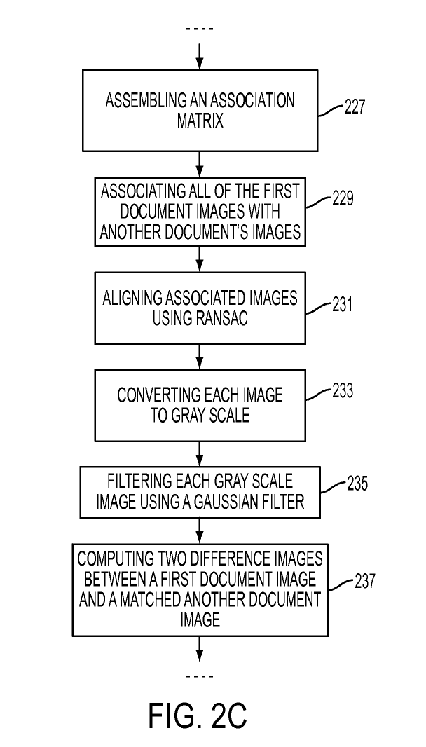

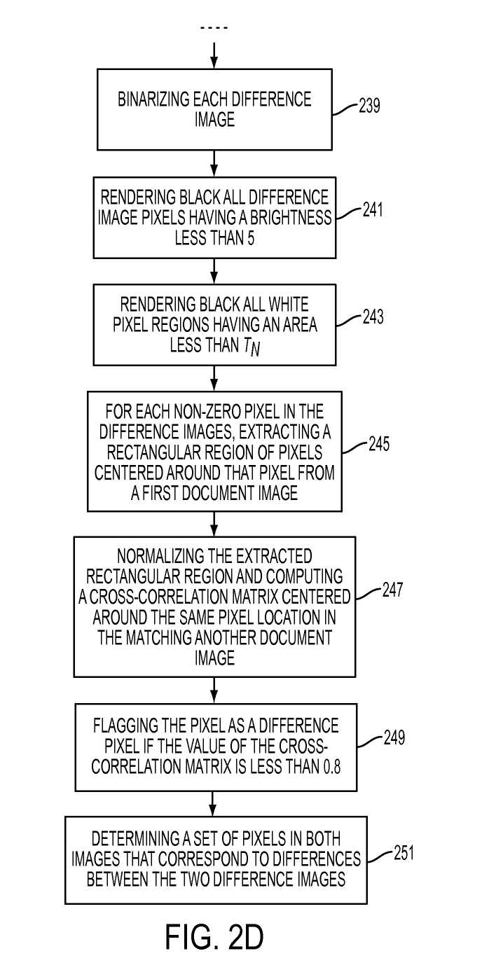

FIG. 1 shows a system architecture 101 and FIG. 2 shows a method. The system architecture 101 comprises a Graphic User Interface (GUI) 103, an object extraction engine 105 and an image matching engine 107. The GUI 103 comprises a content parser 109 and a disparity viewer 111, the object extraction engine 105 comprises a document segmentation module 113 and an object classification module 115, and the image matching engine 107 comprises an image association module 117, an image registration module 119 and a disparity computation module 121.

The GUI 103 allows for user configuration and testing. With it, users can tune the object extraction engine 105 and the image matching engine 107 parameters, and visualize the differences between compared documents. The tuning parameters input by the user comprise a threshold T_{N} that controls the amount of image noise that is ignored and an optional page range parameter R. For every image extracted in a first document, page range parameter R limits the search range of a match in another document and increases the computational performance of the image association module 117.

The content parser 109 receives two or more documents input in a pdf or PostScript format, for example, document 1 and document 2 (steps 201, 203). The input can vary from one paragraph of content to documents in a file system. The object extraction engine 105 outputs a set of images extracted from each document.

The document segmentation module 113 receives and parses the raw documents input and segments pages into different regions by detecting white spaces between various object regions in the horizontal and vertical directions. In cases when the background is darker than the text, the document is first pre-processed and converted into its negative by changing the brightness of all the pixels in the document. This is performed by subtracting the original brightness of each pixel from the maximum of the brightness of all the pixels in the document.

The segmented object regions for each document are passed to the object classification module 115. The object classification module 115 classifies each document page segmented object region as images or text using a learning-based algorithm. The classified object regions for each document are passed to the image association module 117.

The image association module 117 receives the extracted images from the object classification module 115 and given the sets of extracted document images, the image association module 117 finds an association between every image from every document. Given the matched image pairs, the image registration module 119 aligns the two images with one another. Finally, the disparity computation module 121 computes the disparity between the two aligned images. The disparity results are displayed in the disparity viewer 111.

The document segmentation module 113 employs an x-y cut algorithm that segments an entire document page into different object regions. Document pages are input and first converted to a black and white binary format using a fixed threshold T_{B}. All pixels having a brightness less than T_{B} are rendered white while pixels greater than or equal to T_{B} are rendered black (step 205).

The binarized document pages are projected onto x (abscissa) and y (ordinate) axes of the page and a histogram over the number of white pixels is computed along each of the two axes (steps 207, 209). A “valley” in a histogram is defined as the region between its two peaks and corresponds to the white region between two adjacent object regions. Such “valleys” along these two histograms are determined, and a cut at that location on that page of the document along that axis is performed if the area of the enclosed object region is greater than a fixed area threshold T_{A} and the width between two valleys is greater than T_{W} pixels (steps 211, 213). The method is repeated recursively to extract rectangular object regions from a document page. Values of T_{A}=400 and T_{W}=3 provide adequate page segmentation of object regions.

After the document pages have been segmented into object regions, the object regions are classified 115 as images or text. Embodiments use a novel learning-based approach to train a boosted classifier to differentiate between the two classes using color moment based features. These features include the mean and standard deviation of the color distributions of each object region. Since the variance of color in text object regions is usually small compared to that of image object regions, these features are appropriate to capture the differentiating characteristics of the two underlying classes (step 215).

The image association module 117 finds for each image in the first document, an appropriate match with an image in another document. The algorithm is capable of detecting a situation where an appropriate match in another document is missing.

Embodiments reduce complexity by downsampling large (>1,000×1,000 pixels) images using a factor of two in both x and y axes of the image (step 217). During image association, only copies of the original images are downsampled. The original images are not modified. The resulting images are one fourth of their original size before matching. To find an appropriate match, every image extracted from the first document is compared with every image extracted from another document. For example, if there are m images extracted from document 1 and n images extracted from document 2, a total of m×n matching operations are performed. For each match, an association score is computed. An image from the first document is associated with an image of the second document for which the score is maximum.

To compute an association score between two images, embodiments use a Scale-Invariant Feature Transform (SIFT) (step 219). SIFT is robust to variations in image scale and rotation. Matching images with different resolutions, sizes and orientations is not an issue. However, this task may be cumbersome if the number of images in both documents under comparison is very large.

Given two images for association, the extracted SIFT features are stored in a kd-tree (k-dimensional tree) data structure for searching the matches efficiently (step 221). By adding the scores of the individual matches returned by the SIFT matching algorithm, an overall pair-wise association score between the two images is computed. To make the matching algorithm more robust to false matches, embodiments compute a matching score bi-directionally (step 223). The sum of the two directional scores obtained using bi-directional matching gives an overall measure of association between the images (step 225).

Given m images extracted from the first document and n images extracted from the second document, an m×n dimensional association matrix is assembled where the (i,j)-th entry of the matrix gives the association score between the i-th images extracted from page P1ᵢ in the first document with the j-th images, extracted from page P2ⱼ in the second document (step 227). If the absolute difference between P1ᵢ and P2ⱼ, (|P1ᵢ−P2ⱼ|) is more than the page range parameter R provided by the user, the (i,j)-th entry of the association matrix is set to zero. The column and row index of maximum value of the m×n dimensional association matrix gives the best matching image pair. The corresponding column and row are then deleted and the process is repeated until either the maximum score in the association matrix becomes less than a fixed maximum threshold T_{M}, or all of the images from the first document are associated with corresponding images from the second document (step 229).

Once the images in the first document have been associated with the images in another document, the image registration module 119 aligns the matched pair of images with each other. However, the two images can have different sizes or orientations and aspect ratio. This could happen due to resizing or redrawing of an image or deletion/addition of certain components in a newer version of the document.

For an accurate comparison it is important to transform one or both of the images so that the two are aligned properly (step 231). Alignment operations like stretching, skewing and rotating an image, especially for low resolution images usually amounts to additional image noise. The applied transformation operations for the alignment provide accuracy up to the sub-pixel level to minimize noise.

Similar to the image association module 117, embodiments extract and match SIFT features. However, as opposed to image association, where m×n image matching operations are performed to establish association among two sets of images, during image registration 119, at most min(m,n) pairs of images are matched since an image from the first document is only matched to its associated image in another document. Also, the accuracy of the feature matching should be higher in this step than in image association, so that a proper alignment is ensured.

Due to these reasons, embodiments do not downsample the original images before extracting the SIFT features. To limit the computation time for large images, the maximum number of SIFT features to be extracted can be provided to the algorithm.

Image alignment operations like stretching, rotation and skewing all correspond to affine image transformation. Corresponding points in two images under affine transformation are related as

$$[ \begin{matrix}{x}_{1} \\ {y}_{1} \\ 1\end{matrix} ] = T [ \begin{matrix}{x}_{2} \\ {y}_{2} \\ 1\end{matrix} ] \qquad ( 1 )$$

where (x₁,y₁) and (x₂,y₂) are the coordinates of the matching points in the first and second images respectively. An affine transformation is a linear transformation and is represented by a 3×3 matrix T as

$$T = [ \begin{matrix} & & {t}_{x} \\ A & & \\ & & {t}_{y} \\ 0 & 0 & 1\end{matrix} ] \qquad ( 2 )$$

where tₓ and t_{y} are translations along x and y axes of the image. The 2×2 matrix A is the scaling and rotation matrix and can be further decomposed into three 2×2 matrices—two rotation matrices and one scale matrix as follows

A=R₁R₂^{T}SR₂ (3)

where both the rotation matrices are of the form

$$\begin{matrix}{R}_{1} = [ \begin{matrix}cos θ & - sin θ \\ sin θ & cos θ\end{matrix} ] , and & ( 4 ) \\ {R}_{2} = [ \begin{matrix}cos φ & - sin φ \\ sin φ & cos φ\end{matrix} ] & ( 5 )\end{matrix}$$

and the scale matrix is diagonal of the form

$$S = [ \begin{matrix}{s}_{x} & 0 \\ 0 & {s}_{y}\end{matrix} ] \qquad ( 6 )$$

where sₓ and s_{y} are scaling factors along the x and y axes of the image respectively. With six unknowns θ, φ, sₓ, s_{y}, tₓ and t_{y}, at least three (non-collinear) image point matches are required to uniquely determine the T matrix.

Since there are typically many more point matches, a least squares estimation is usually performed to achieve the best overall transformation. However, like any image matching algorithm, SIFT feature matching also suffers from the problem of false point matches. Therefore, it is not possible to align the two images properly using the least square estimation over the entire set of point matches.

To overcome this problem, embodiments use the RANdom SAmple Consensus (RANSAC) method to robustly estimate the transformation matrix T from the inliers (correct point matches) while simultaneously rejecting the outliers (wrong matches). The obtained transformation T is then applied to the second image using bilinear interpolation to obtain an image which is aligned to the first image.

After two images are aligned using the robust image alignment method described above, each of the two images is converted to a [0-255] level grayscale image (step 233). Both the grayscale images are filtered using a Gaussian filter with a bandwidth of 3 pixels (step 235).

Two “difference images” are obtained by subtracting each image from the other (step 237). This is achieved by subtracting the brightness of each pixel in the first image from that of the corresponding pixel in the second image and vice-versa. Each difference image is binarized into a black and white image (step 239). In order to do so, all the pixels in the difference image having a grayscale value less than 5 are rendered black and the remaining pixels are rendered white (step 241). Thereafter, all of the white pixel regions whose area is less than a fixed maximum threshold T_{N} are also rendered black (step 243).

To compute a view showing the disparity between two images, all of the pixels in both difference images with non-zero values are used. For each non-zero pixel location, an 11×11 rectangular pixel region centered around that specific pixel location is extracted from the first (template) image (step 245). A region-based normalized cross-correlation matrix is computed with the 15×15 region centered on the same pixel location in the second (target) image (step 247).

A match is defined if the maximum value of the cross-correlation matrix is above 0.8. Otherwise, the pixel is flagged as a difference pixel (step 249).

The above method is performed over all of the non-zero pixels for both difference images to arrive at a set of pixels in both difference images that correspond to the differences in the two images at a pixel level (step 251).

The nearby pixels of these individual sets are merged together to show the difference between two or more images. During merging, two disparity views are created. A first disparity view for differences in the first document's images and a second disparity view for differences in the second document's matching images. Each disparity view shows what is present in one image and not present in the other. The difference regions are bounded by rectangular boxes and highlighted by the disparity viewer 111 in the corresponding images as the output.

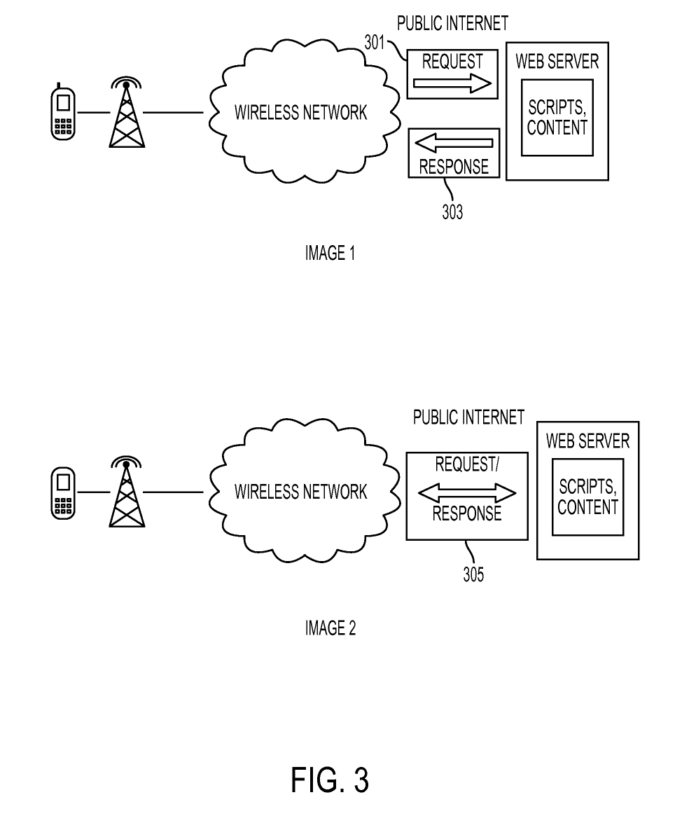

FIG. 3 shows an example of the image comparison results obtained using the embodiments. The disparity viewer 111 indicates disparities between an image in a first document (image 1) and in a matched image in another document (image 2) by surrounding the disparate regions with blue 301, 303 and red 305 color rectangles. The rectangles enclose regions in an image in a first document that are disparate from the corresponding regions in the matched image in another document.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for comparing images contained in documents comprising:
inputting a first document;
inputting another document;
segmenting the pages of the first and another documents into object regions;
classifying the object regions as text and images;
associating the images from the first document with images from the another document;
aligning the associated images using an affine transformation;
computing a disparity in the associated images using cross correlation; and
displaying the disparity in each aligned, associated pair of images.

2. The method according to claim 1 wherein segmenting document pages further comprises:
binarizing the first and another document pages as black and white using a predefined threshold T_{B};
projecting each binarized document page onto x and y axes of the page;
computing a page histogram over the number of white pixels along the x and y axes of the page;
determining valleys along each page histogram that define an enclosed object region; and
if the area of an enclosed object region is greater than an area threshold T_{A} and the width between two valleys is greater than T_{W} pixels, segmenting that object region from the document page.

3. The method according to claim 2 wherein the area threshold T_{A} is 400.

4. The method according to claim 2 wherein the width threshold T_{W} is 3.

5. The method according to claim 1 wherein classifying an object region further comprises using color moment based features.

6. The method according to claim 5 wherein the color moment based features comprises the mean and standard deviation of the color distributions of an object region.

7. The method according to claim 6 wherein a learning-based boosted classifier classifies an object region.

8. The method according to claim 1 wherein associating an image from the first document with an image from another document further comprises:
downsampling each image from the first and another documents;
computing a measure of association between a first document image and another document image using a Scale-Invariant Feature Transform (SIFT);
storing SIFT features extracted from the first document images and the another document images in a kd-tree (k-dimensional tree) data structure;
searching for image matches between the first and the another document images;
computing bi-directional pairwise scores between the first document images and the another document images;
summing the directional pairwise scores as a measure of association between a first document image and another document image;
assembling an association matrix; and
associating all of the first document images with the another document images.

9. The method according to claim 1 wherein aligning each associated pair of images from the first and the another documents further comprises:
converting each image to grayscale;
filtering each grayscale image using a Gaussian filter; and
computing two difference images between a first document image and a matched another document image comprising:
binarizing each difference image into black and white by rendering black all difference image pixels having a grayscale level less than 5 and rendering white all the remaining pixels; and
rendering black all white pixel regions having an area less than a fixed maximum threshold T_{N}.

10. The method according to claim 1 wherein displaying the disparities in each aligned, associated pair of images further comprises:
for each non-zero, non-edge pixel from a first document image, extracting a rectangular region of pixels centered around that pixel;
normalizing the extracted rectangular region and computing a cross-correlation matrix centered around the same pixel location in the matching aligned, associated image in the another document;
flagging the non-zero pixel as a difference pixel if the maximum value in the cross-correlation matrix is less than 0.8; and
determining a set of pixels in both the aligned, associated image of the first document and the another document image that correspond to differences.

11. A system for comparing images contained in documents comprising:
means for inputting a first document;
means for inputting another document;
means for segmenting the pages of the first and another documents into object regions;
means for classifying the object regions as text and images;
means for associating the images from the first document with images from the another document;
means for aligning the associated images using an affine transformation;
means for computing a disparity in the associated images using cross correlation; and
means for displaying the disparity in each aligned, associated pair of images.

12. The system according to claim 11 wherein means for segmenting document pages further comprises:
means for binarizing the first and another document pages as black and white using a predefined threshold T_{B};
means for projecting each binarized document page onto x and y axes of the page;
means for computing a page histogram over the number of white pixels along the x and y axes of the page;
means for determining valleys along each page histogram that define an enclosed object region; and
if the area of an enclosed object region is greater than an area threshold T_{A} and the width between two valleys is greater than T_{W} pixels, means for segmenting that object region from the document page.

13. The system according to claim 12 wherein the area threshold T_{A} is 400.

14. The system according to claim 12 wherein the width threshold T_{W} is 3.

15. The system according to claim 11 wherein means for classifying an object region further comprises using color moment based features.

16. The system according to claim 15 wherein the color moment based features comprises the mean and standard deviation of the color distributions of an object region.

17. The system according to claim 16 wherein a learning-based boosted classifier classifies an object region.

18. The system according to claim 11 wherein means for associating an image from the first document with an image from another document further comprises:
means for downsampling each image from the first and another documents;
means for computing a measure of association between a first document image and another document image using a Scale-Invariant Feature Transform (SIFT);
means for storing SIFT features extracted from the first document images and the another document images in a kd-tree (k-dimensional tree) data structure;
means for searching for graphics object region matches between the first and the another document images;
means for computing bi-directional pairwise scores between the first document images and the another document images;
means for summing the directional pairwise scores as a measure of association between a first document image and another document image;
means for assembling an association matrix; and
means for associating all of the first document images with the another document images.

19. The system according to claim 11 wherein means for aligning each associated pair of images from the first and the another documents further comprises:
means for converting each image to grayscale;
means for filtering each grayscale image using a Gaussian filter; and
means for computing two difference images between a first document image and a matched another document image comprising:
means for binarizing each difference image into black and white by rendering black all difference image pixels having a grayscale level less than 5 and rendering white all the remaining pixels; and
means for rendering black all white pixel regions having an area less than a fixed maximum threshold T_{N}.

20. The system according to claim 11 wherein means for displaying the disparities in each aligned, associated pair of images further comprises:
for each non-zero, non-edge pixel from a first document image, means for extracting a rectangular region of pixels centered around that pixel;
means for normalizing the extracted rectangular region and computing a cross-correlation matrix centered around the same pixel location in the matching aligned, associated image in the another document;
means for flagging the non-zero pixel as a difference pixel if the maximum value in the cross-correlation matrix is less than 0.8; and
means for determining a set of pixels in both the aligned, associated image of the first document and the another document image that correspond to differences.
